(19) United States
(12) Patent Application Publication
(10) Pub. No.: US 2007/0226980 A1
(43) Pub. Date: Oct. 4, 2007

(54) Apparatus for installing a fastener

(76) Inventors: Janusz Lachowski, Plymouth, MI (US); Christopher Krystek, Lake Orion, MI (US)

Correspondence Address: VAN OPHEM & VANOPHEM, PC;REMY J VANOPHEM, PC, 51543 VAN DYKE, SHELBY TOWNSHIP, MI, 48316-4447, US

(21) Appl. No.: 11/392,422

(22) Filed: Mar. 29, 2006

(51) Int. Cl. B23P 19/04

(52) U.S. Cl. 29/225

(57) ABSTRACT

An apparatus for installing a fastener on a workpiece, typically a resilient retainer clip or spring fastener attached to a post or projecting member on the workpiece. The apparatus has a floating coupling that enables the fastener holder and correspondingly the fastener to vary its orientation. Accordingly, as the fastener is installed on the post or projecting member, the fastener self-aligns to the post or projecting member such that the fastener is properly seated on the base of the post or projecting member.

### CROSS-REFERENCE TO RELATED APPLICATIONS

Not Applicable

### BACKGROUND OF THE INVENTION

1. Field of the Invention

The present invention relates generally to an apparatus for installing a fastener. More specifically, this invention is directed to a self-aligning apparatus that installs a fastener.

2. Description of Related Art

A resilient clip or spring fastener generally includes a compressible member for releasably securing an object to a base or support member. For example, automotive vehicles typically use a resilient clip or spring fastener to secure a removable vehicle trim piece or cover panel to an automotive interior panel. The resilient clip or spring fastener is mounted to a post or rib located on the inner or back surface of the trim piece or cover panel. To fasten the trim piece or cover panel to an automotive interior panel within the vehicle, the post and clip assembly is inserted and extends into a slot or opening formed in a base member or support member of the automotive interior panel. When properly aligned, the compressible portion of the resilient clip assembly secures the removable trim piece or cover panel to the base member by expanding outward against opposed edges of the opening with sufficient force to hold the trim piece or cover panel in place on the base or support member. Various designs of resilient clips or spring fasteners along with their use for attaching removable trim pieces or cover panels in automotive vehicle interiors are known in the prior art.

In many instances, the trim piece or cover panel is molded from a plastic material such as polypropylene. During the molding process, the posts, or other projecting members such as ribs or outwardly extending tabs are integrally molded with and form part of the trim piece or cover panel. The posts or projecting members are of a size and configuration to receive the resilient clip. Accordingly, after forming the trim piece or cover panel, the trim piece or cover panel is placed in a fixture wherein power operated hand tools or automated equipment installs the resilient clips on the posts or projecting members.

Various tools for attaching a resilient clip or spring fastener to a component are known in the prior art. See for example Munse, U.S. Pat. No. 3,501,827 and Munse, U.S. Pat. No. 3,702,494 both of which disclose a power operated tool including a ram assembly that drives a pusher member. The pusher member drives a resilient clip or spring fastener on a trim piece or cover panel. Buttriss, U.S. Pat. No. 4,075,748 discloses an automatic fastener emplacement mechanism for selectively applying fasteners such as spring clips to a workpiece. The mechanism includes a reciprocal ram and a nosepiece located on the ram. The nosepiece holds a fastener whereby the ram supplies the force necessary to install or place the fastener on the trim piece or cover panei.

In addition to a ram driven mechanism for installing or placing a resilient clip or spring fastener, it is also known to use a four bar linkage assembly to drive a fastener holder and correspondingly install a resilient clip held therein in a final, predetermined position on a post or projecting member of the trim piece or cover panel. Like the previously discussed ram driven apparatus, the four bar linkage assembly operates only in two directions of movement; i.e., in a reciprocal or back-and-forth manner.

One disadvantage of the prior art is that as the trim piece or cover panel cools, the post or projecting member extending from the trim piece or cover panel may shift or move, typically due to tolerance variations in the shrinkage rate and amount of the plastic forming the post or projecting member. For example, as the post or projecting member cools, variations in cooling rates may cause the post or projecting member to bend or twist resulting in the axial or mounting centerline being slightly off from its original, mold position.

To install the resilient clip or spring fastener the trim piece or cover panel is placed in a locating fixture such that the post or projecting member is positioned adjacent the clip driver. As set forth above, the driver moves back and forth in a single direction between a load position and an install position. Properly positioning the trim piece or cover panel in the locating fixture does not ensure correct installation of the resilient clip or spring fastener when misalignment of the post or projecting member occurs. Accordingly, even though an operator properly positions the trim piece or cover panel in a locating fixture, the driver will not drive the resilient clip or spring fastener into the proper position on a misaligned post or projecting member. For example, if the axis of the ram and resilient fastener holder is not in axial alignment with the axis of the post or projecting member, proper alignment of the clip will not occur and the clip will not seat properly on the post or projecting member. Misalignment or not fully seating the resilient clip on the post or projecting member may prevent attachment or at the least improper attachment of the trim piece or cover panel to the base member. In addition, it may cause improper seating or unsightly gaps or spaces between the trim piece or cover panel and the base member or the automotive inner panel.

From the above, it can be appreciated that the rigid, two position clip drivers of the prior art are not fully optimized to provide an apparatus that accounts for misalignment between the driver and the post or projecting member when installing a resilient clip or spring fastener on the post or projecting member. Therefore, what is needed is a resilient clip driver that aligns the resilient clip or spring fastener with the post or projecting member during the driving process such that the resilient clip is properly installed on the post or projecting member even if misalignment occurs between the driver and the post or projecting member.

### SUMMARY OF THE INVENTION

According to the preferred embodiment of the present invention, there is provided an apparatus for installing a fastener, such as resilient clip or spring fastener on a post or projecting member of a workpiece. The apparatus accounts for misalignment between the fastener and projecting member to drive and properly seat to the fastener on the projecting member. The apparatus includes a shaft supported for reciprocal movement. A power source connected to the shaft provides power to move the shaft in a reciprocal manner. A fastener holder holds the fastener in position prior to installation. A floating coupling connects the fastener holder to the shaft. In operation, the floating coupling enables the position of the fastener holder and thereby the fastener to float such that the fastener aligns with and is properly seated on the projecting member.

Accordingly, it is an object of the present invention to provide an apparatus for installing a fastener that accommodates misalignment between the fastener and projecting member.

It is another object to provide an apparatus that enables alignment of the fastener with the projecting member when the projecting member is inclined at an angle with respect to the longitudinal axis of the shaft.

It is still another object to provide an apparatus that allows for a variance in the location of the workpiece on the fixture whereby the fastener aligns itself on the projecting member.

It is yet another object to provide an apparatus that provides three positions or stages wherein the apparatus includes a load position.

These objects and other features, aspects and advantages of this invention will be more apparent after a reading of the following detailed description, appended claims and accompanying drawings.

### BRIEF DESCRIPTION OF THE DRAWINGS

FIG. 1 is a perspective view of an apparatus according to the preferred embodiment of the present invention;

FIG. 2 is a front view of the apparatus of FIG.1;

FIG. 3 is a side view of the apparatus of FIG.1;

FIG. 4 is a cross-sectional side view of the coupler and fastener holder assembly of the apparatus of FIG. 1;

FIG. 5 is a cross-sectional side view of the coupler and fastener holder assembly of the apparatus of FIG. 1 illustrating the coupler pivoting to align the fastener;

FIG. 6 is a cross-sectional side view of the coupler and fastener holder assembly of the apparatus of FIG. 1 illustrating the coupler shifting laterally to align the fastener;

FIG. 7 is a cross-sectional front view of the coupler and fastener holder assembly of the apparatus of FIG. 1 illustrating the coupler pivoting to align the fastener;

FIG. 8 is a perspective view of the coupler and fastener holder assembly of the apparatus of FIG. 1 illustrating various directions of coupler movement using a X,Y & Z coordinate axis system;

FIG. 9 is a cross-sectional side view of a second embodiment of the coupler and fastener holder assembly of the apparatus of FIG. 1;

FIG. 10 is a side view of an apparatus according to present Invention illustrated in a load position;

FIG. 11 is a side view of an apparatus according to present invention illustrated in a drive or install position; and

FIG. 12 is a side view of an apparatus according to present invention illustrated in a home position.

### DETAILED DESCRIPTION OF THE PREFERRED EMBODIMENTS

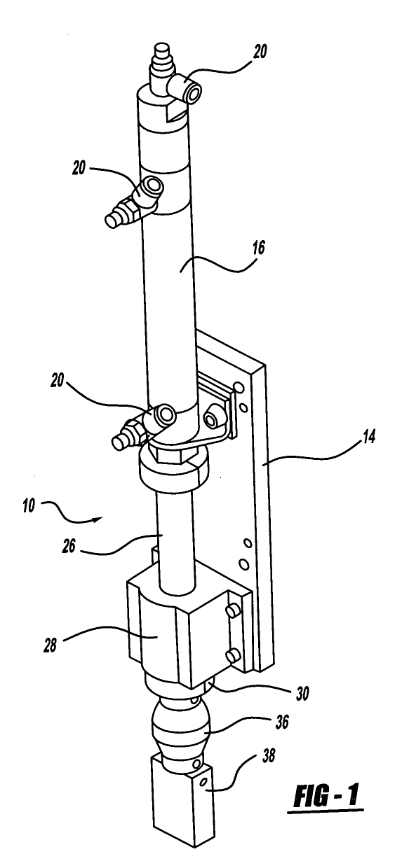

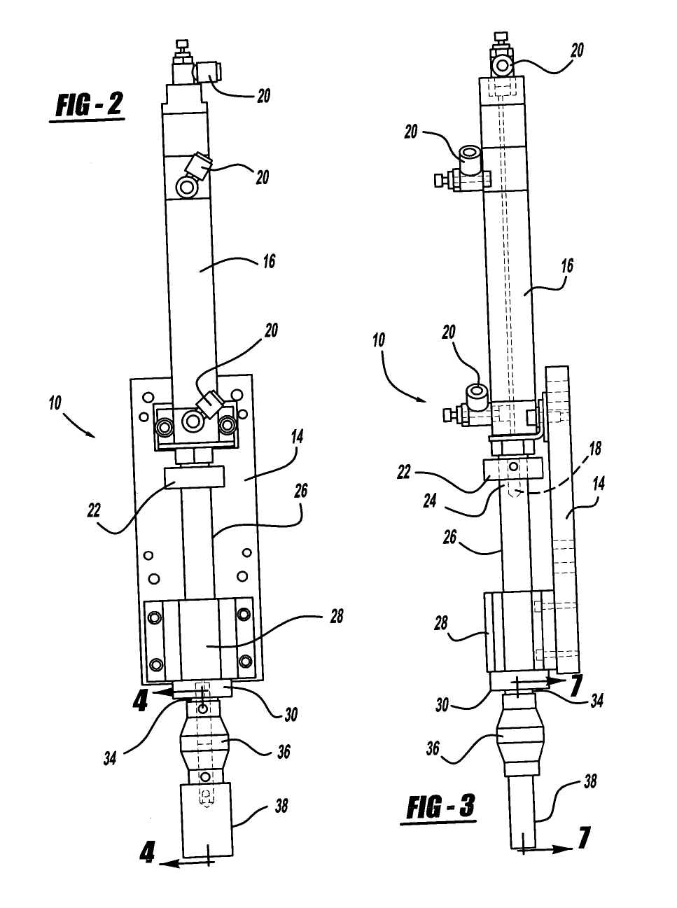

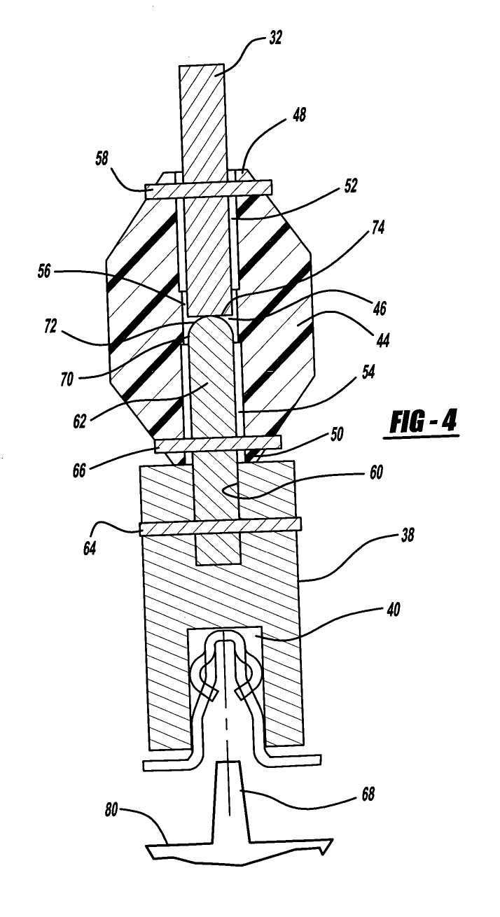

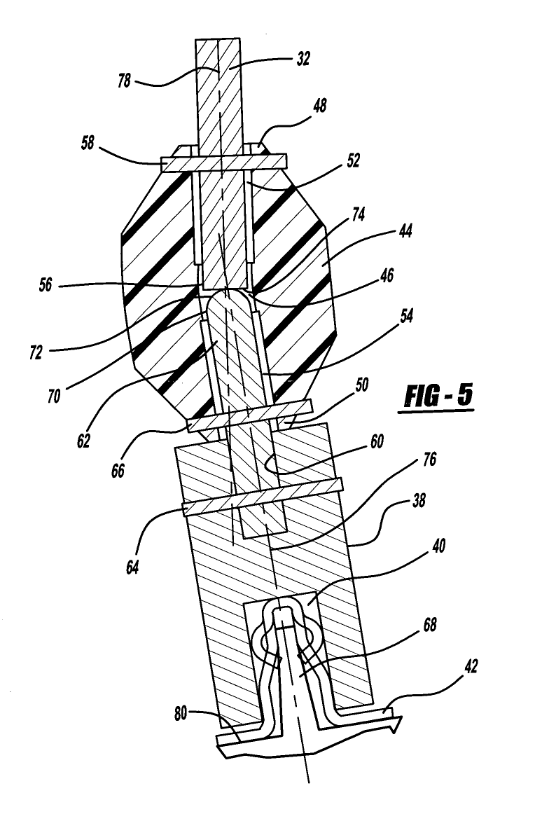

Turning now to FIGS. 1-3 there is shown an apparatus, seen generally at 10, for installing a fastener on a workpiece. While illustrated herein installing a resilient retainer clip fastener 42 (shown in FIG. 4), the apparatus 10 is suitable for installing other types of fasteners including spring fasteners, U-shaped nuts and similar type fasteners. The apparatus 10 includes a support or mounting plate 14. Attached to the support is a power cylinder 16 including a piston rod 18 mounted for reciprocal movement within the power cylinder 16. The power cylinder 16 is typically fluid driven, either hydraulic or pneumatic, and includes a plurality of fluid ports 20 for receiving fluid from a pressure source, not shown. Accordingly, as known, fluid applied to one of the fluid ports 20 acts on a piston contained within the power cylinder 16 to move the piston rod 18 in a reciprocating manner. While the apparatus 10 is shown in the preferred embodiment with a fluid operated power cylinder, other types of reciprocal drive mechanisms including a mechanical drive system such as a screw drive may also be used.

A shaft collar 22 attaches a first end 24 of a drive shaft 26 to the piston rod 18. A pillow block 28 secured to the support 14 slidably supports the drive shaft 26 for reciprocal movement. Accordingly, as the power cylinder 16 is actuated, the drive shaft 26 moves in a reciprocal manner along its longitudinal axis. A second shaft collar 30 connects a coupling shaft 32 to a second end 34 of the drive shaft 26. A resilient floating coupling 36 is attached between the coupling shaft 32 and the fastener holder 38. As illustrated in FIG. 4 the fastener holder 38 contains a socket or cavity 40 configured to receive the retainer clip 42. As is known in the art, the retainer clip 42 is placed in the socket or cavity 40 and is retained therein by various means including a friction interface fit, a magnetic or vacuum/suction assembly in preparation of the installation procedure.

Referring still to FIG. 4, the resilient floating coupling 36 and fastener holder 38 are shown in greater detail. The floating coupling 36 includes an elastomeric body 44 having a longitudinal passageway 46 extending through the elastomeric body 44 from a first end 48 to a second end 50. A first bushing or sleeve 52 is located in the passageway 46 adjacent the first end 48 of the elastomeric body 44. A second bushing or sleeve 54 is located in the passageway 46 adjacent the second end 50 of the elastomeric body 44. As illustrated, the first and second bushings 52, 54 do not extend the entire length of the passageway 46 and leave a space or gap 56 between them.

To mount the floating coupling 36 to the coupling shaft 32, the coupling shaft 32 is inserted into the first bushing 52 until it extends past the first bushing 52 and into the gap 56 between the first and second bushings 52, 54. A roll pin 58 located at the first end 48 of the elastomeric body 44 extends through the bushing 52 and coupling shaft 32 to secure the floating coupling 36 to the coupling shaft 32. One end of a connection shaft 62 is positioned within a cavity 60 on the fastener holder 38. A roll pin 64 extending through the fastener holder 38 and the connection shaft 62 secures the fastener holder 38 to the connection shaft 62. The fastener holder 38 is secured to the floating coupling 36 by inserting the connection shaft 62 into the second bushing 54 until it contacts the coupling shaft 32. A roll pin 66 extends through the second end 50 of the elastomeric body 44 and through both the second bushing 54 and the connection shaft 62 to secure the connection shaft 62 and correspondingly the fastener holder 38 to the resilient floating coupling 36. Accordingly, the respective centerlines of the coupling shaft 32 and the connection shaft 62 are coaxial.

The connection shaft 62 includes an arcuate or curved surface 72 located on the end 70 of the connection shaft 62 located in the elastomeric body 44 of the floating coupling 36. The arcuate or curved surface 72 contacts the flat or planar end 74 of the coupling shaft 32. Accordingly, the power cylinder 16 transmits the axial load necessary to install the retainer clip 42 through the drive shaft 26 and coupling shaft 32 to the connection shaft 62 and correspondingly to the retainer clip 42 through the fastener holder 38. Providing an arcuate or curved surface 72 facilitates both angular and rotational movement of the fastener holder 38 with respect to the coupling shaft 32.

As the illustrated in FIG. 4, the retainer clip 42 held in the fastener holder 38, is positioned adjacent a post or projecting member 68 formed as a part of a trim piece or trim panel prior to installation. When, as illustrated in FIG. 4, the centerline of the post or projecting member 68 is in line with or coaxial with the centerline of the retainer clip 42 and connection shaft 62 actuation of the power cylinder 16 drives the retainer clip 42 onto the post or projecting member 68 and against the base surface 80 of the trim panel to properly seat the retainer clip on the trim panel. If, however, the respective centerlines are not aligned or coaxial, the floating coupling 36 enables the fastener holder 38 and correspondingly the retainer clip 42 to shift, rotate about its axis and/or pivot to adjust for misalignment between the retainer clip 42 and the post or projecting member 68. It should be understood that if the retainer clip 42 is not properly seated on the base surface 80 of the trim panel, the trim panel may not mount properly or be improperly secured to the vehicle's interior panel and could come loose as a result of road vibrations.

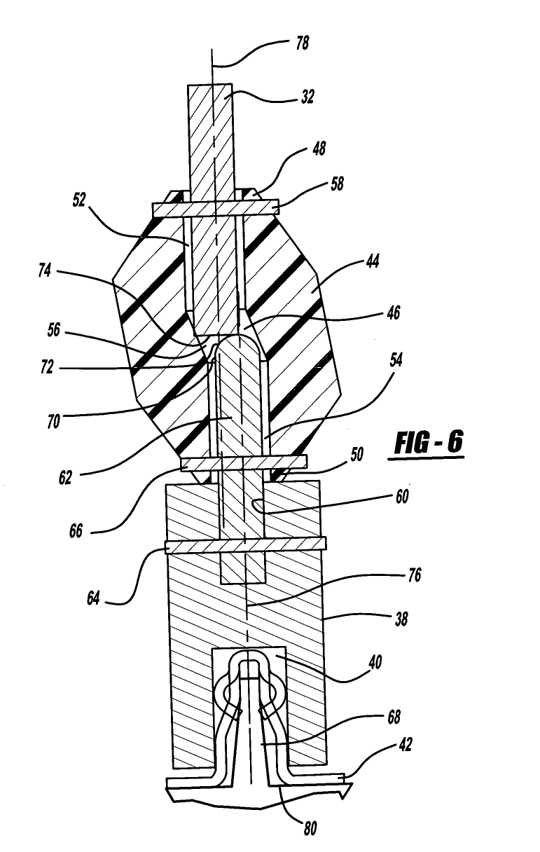

FIGS. 5-7 show several exaggerated misalignment conditions of the self-alignment feature of the floating coupling 36 can accommodate to insure that the fastener holder 38 which properly installs the retainer clip 42 on a misaligned post or projecting member 68. FIG. 5 illustrates one embodiment of the present invention installing a retainer clip 42 on a post or projecting member 68 wherein the centerline or longitudinal axis 76 of the post 68 is skewed in an aft direction with respect to the centerline 78 of the coupling shaft 32 and corresponding drive shaft 26. It should be understood that when the retainer clip 42 contained in the fastener holder 38 engages a skewed post or projecting member 68 the curved or contoured surface 72 of the connection shaft 62 allows the fastener holder 38 to pivot with respect to the coupler shaft 32 as the arcuate or curved surface 72 of the connection shaft 62 pivots on the planar end 74 of the coupling shaft 32. Accordingly, the floating coupling 36 enables the fastener holder 38 to shift or rotate, as well as, and/or pivot as necessary to align and properly install the retainer clip 42 on the base 80 of the post or projecting member 68 such that the retaining clip 42 is completely seated on the base 80 of the projecting member 68.

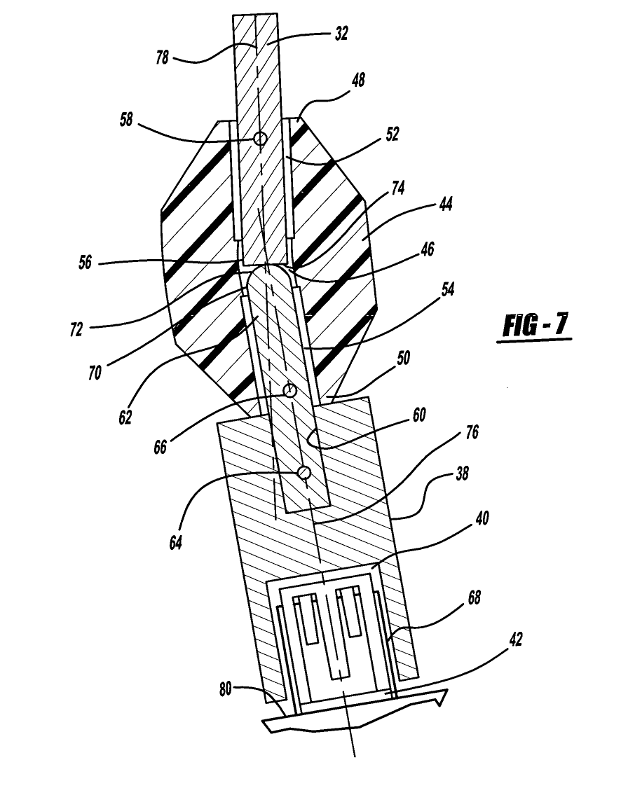

FIG. 6 illustrates another example of the apparatus of the present invention installing a retainer clip 42 on a post or projecting member 68 wherein the centerline 76 of the post 68 is parallel to and offset from the centerline 78 of the coupling shaft 32 and corresponding drive shaft 26. As shown therein, the fastener holder 38 shifts laterally with respect to the coupling shaft 32 as the arcuate or curved surface 72 slides on the planar end 74 of the coupling shaft 32 wherein the retainer clip 42 is properly aligned with and installed such that the retaining clip 42 is properly seated to the base 80 of the post or projecting member 68. It should be understood that the flexibility of the elastomeric body 44, enables the fastener holder 38 to move or shift position as necessary to align and properly seat the retainer clip 42 on the base 80 of the post or projecting member 68.

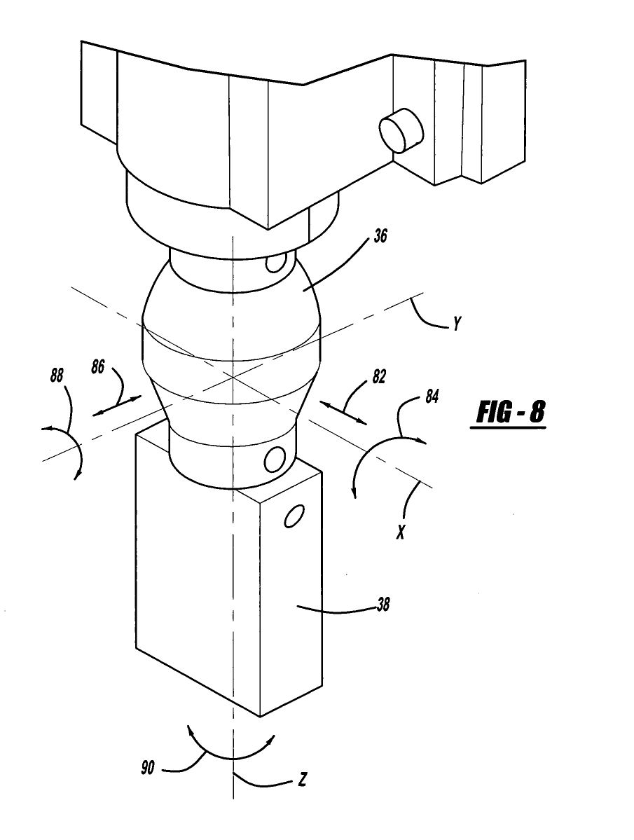

FIG. 7 illustrates another example of the apparatus of the present invention properly seating a retainer clip 42 on the base 80 of the post or projecting member 68 wherein the centerline 76 of the post 68 is skewed in a side to side direction as opposed to the fore or aft direction illustrated in FIG. 5. Again, the floating coupling 36 shifts, rotates and/or pivots, as necessary, to properly seat the retaining clip 42 on the base 80 of the post 68.

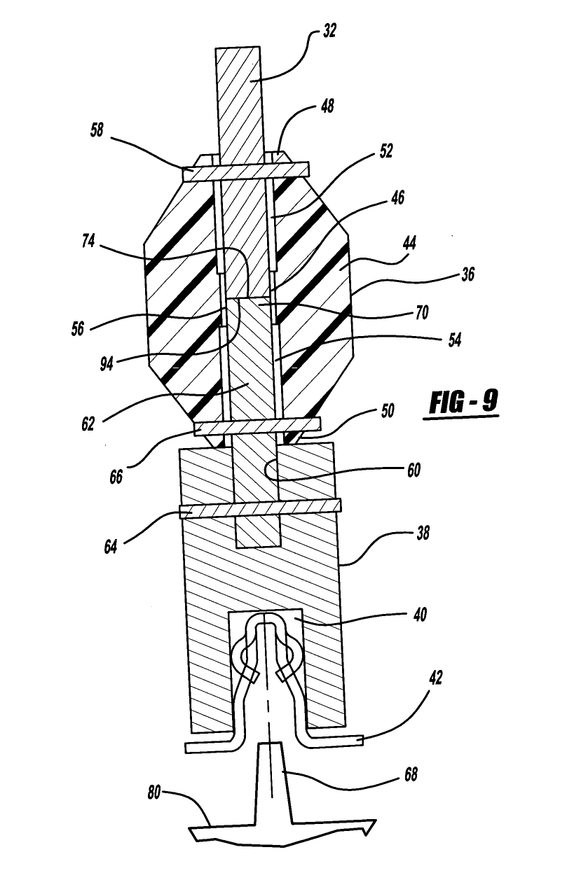

FIG. 8 illustrates an X, Y & Z axis coordinate system showing all of the directions in which the floating coupling 36 enables the fastener holder 38 to move, shift, rotate and/or pivot to orient the fastener 42 and thus properly install the fastener 42 on the base 80 of the post 68. As illustrated, the fastener holder 38 moves laterally along the X-axis or rotates about the X-axis as illustrated by the arrows 82, 84. The fastener holder also moves laterally along the Y-axis or rotates above about the Y-axis as illustrated by the arrows 86, 88. In addition, the fastener holder 38 also rotates about the Z-axis as illustrated by the arrow 90. It should be understood that the floating coupling 36 enables the fastener holder 38 to move in any or all of the above described directions as needed to orient the fastener 42 such that it is properly seated on the base 80 of the post 68. For example, the fastener holder 38 may shift laterally along the X-axis as illustrated by the arrow 82 while also rotating about the Z-axis as illustrated by the arrow 90. This is but one example, and it should be understood that the floating coupling 36 of the present invention enables the fastener holder 38 to move in any number of directions.

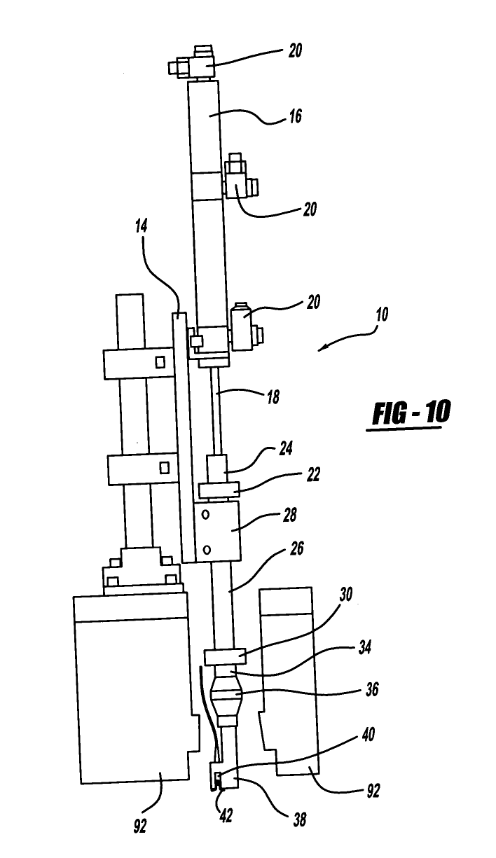

FIG. 9 illustrates a second embodiment of the present invention wherein the end 70 of the connection shaft 62 has a flat or planar surface 94 that engages the flat or planar end 74 of the coupling shaft 32. This embodiment functions the same as the previous embodiment in that the coupling shaft 32 and connection shaft 62 are free to move with respect to one another. Other configurations of the respective ends of the coupling shaft 32 and the connection shaft 62 are contemplated.

Accordingly, as set forth above, the floating coupler 36 enables the fastener holder 38 and retainer clip 42 contained therein to shift both laterally and longitudinally to properly align and position the retainer clip 42 on the post or projecting member 68. The floating coupling 36 enables the fastener holder 38 and correspondingly the retainer clip 42 contained therein to rotate about its centerline or longitudinal axis and move longitudinally to align the centerline of the fastener holder 38 and retainer clip 42 with the centerline of the post 68 thereby accommodating angular variations of the post or projecting member 68. Thus, the floating coupling 36 of the present invention provides a mechanism to reorient the lateral, longitudinal, and angular position of the corresponding fastener holder 38 and retainer clip 42 to properly seat the retainer clip 42 on the base 80 of the post or projecting member 68.

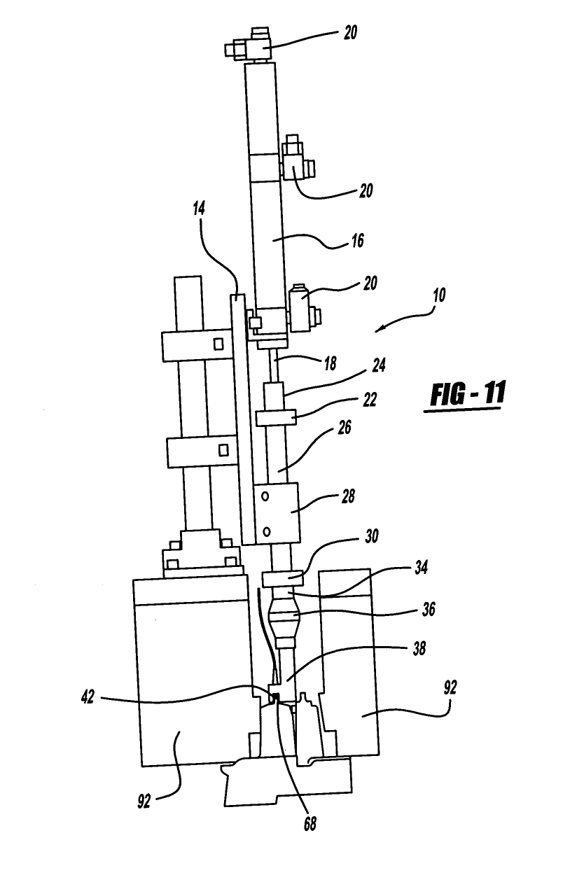

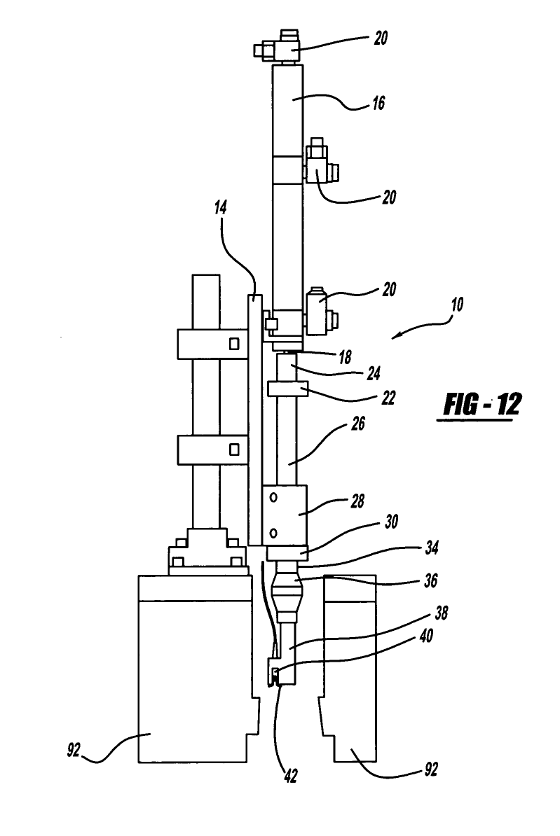

Turning now to FIGS. 10-12 there is shown various stages or positions of the apparatus 10 used to attach or install the retainer clip 42 to the post or projecting member 68 of a trim piece or cover panel. Initially, as shown the apparatus 10 is positioned in a home position, see FIG. 12, wherein the fastener holder 38 is drawn into or above a fixture 92 used to position the trim piece or panel such that the post or projecting member 68 is positioned near the retainer clip 42 located in the fastener holder 38. From this home or at rest position, the operator actuates a control mechanism (not shown) that causes actuation of the power cylinder 16 to move the fastener holder 38 to a load position as illustrated in FIG. 10. Once the retainer clip 42 is loaded, the control mechanism actuates the power cylinder 16 to withdraw or return the fastener holder 38 to the home position. After the fastener holder 38, with the retainer clip 42 loaded therein, is returned to the home position the trim piece or panel is placed on the fixture 92. Once the trim piece or panel is properly located on the fixture 92, the control mechanism actuates the power cylinder 16 that provides the force to drive the retainer clip 42 on to the post or projecting member 68 and properly seat the retainer clip 42 on the base 80 of the trim piece or cover panel.

As set forth previously, if misalignment occurs when the retainer clip is being driven on to the post or projecting member 68, the floating coupling 36 allows movement of the fastener holder 38 and correspondingly the retainer clip 42 such that the retainer clip 42 aligns itself to the orientation of the post or projecting member 68 such that it is properly attached and seated on the base 80 of the post or projecting member 68. Accordingly, since the retainer clip 42 wants to center itself on the post 68, the floating coupling 36 moves as necessary to compensate for any misalignment between the retainer clip 42 and the post 68.

Thus, the present invention provides an apparatus to properly install a resilient retainer clip or spring fastener to a trim piece or cover panel wherein the apparatus functions to self-align the retainer clip to the post or projecting member and completely locate or attach the retainer clip on the base of the projecting member. The present invention overcomes misalignment and tolerance variation caused by material shrinkage, fixture tolerances and any angularity or other misalignment of the post resulting in proper attachment of the retainer clip to the trim pad. As set forth above, the apparatus transmits a linear axial force to drive the fastener onto the post while the floating coupling compensates for misalignment between the post or projecting member and retainer clip.

While the present invention has been described in terms of a preferred embodiment, it is apparent that other forms could be adopted by one skilled in the art. In other words, the teachings of the present invention encompass any reasonable substitutions or equivalents of claim limitations. Accordingly, the scope of the present invention is to be limited only by the following claims.

What is claimed is:

1. An apparatus for installing a fastener comprising:
a shaft supported for reciprocal movement;
a power source connected to said shaft and operative to move said shaft;
a fastener holder;
a floating coupling connecting said shaft to said fastener holder.

2. An apparatus for installing a fastener as set forth in claim 1 wherein said power source includes a power cylinder having a reciprocating piston rod located therein.

3. An apparatus for installing a fastener as set forth in claim 1 including:
a mounting plate;
a pillow block attached to said mounting plate and said power cylinder attached to said mounting plate; and
said shaft slidably supported in said pillow block and connected to said power source such that actuation of said power source causes movement of said shaft.

4. An apparatus for installing a fastener as set forth in claim 1 wherein said floating coupling includes:
a flexible member having opposing ends, said fastener holder connected to one end of said flexible member and said shaft connected to an opposite end of said flexible member.

5. An apparatus for installing a fastener as set forth in claim 1 including:
a connection shaft, said connection shaft having first and second ends, said fastener holder secured to said second end of said connection shaft and said first end of said connection shaft secured to said floating coupling; and
said drive shaft including a drive end, said drive end secured to said floating coupling and contacting said first end of said connection shaft.

6. An apparatus for installing a fastener as set forth in claim 5 including said floating coupling including a flexible member having opposing ends and a passageway extending through said flexible member between said opposing ends; and
said connection shaft disposed in said passageway and said coupling shaft disposed in said passageway.

7. An apparatus for installing a fastener as set forth in claim 6 including a first bushing located in said passageway adjacent one end of said flexible member and a second bushing located in said passageway adjacent said opposing end of said flexible member said bushings spaced apart from one another.

8. An apparatus for installing a fastener as set forth in claim 7 wherein said drive end includes a coupler shaft, said coupler shaft disposed in and extending past said first bushing and said connection shaft disposed in and extending past said second bushing and contacting said coupler shaft.

9. An apparatus for installing a fastener as set forth in claim 8 wherein said connection shaft has a contact end and said coupler shaft has a contact end, said contact end of said connection shaft contacting said contact end of said coupler shaft and at least one of said contact ends having an arcuate surface.

10. An apparatus for installing a fastener as set forth in claim 9 wherein said arcuate surface is a spherical surface.

11. An apparatus for installing a fastener as set forth in claim 4 wherein said flexible member is an elastomeric member.

12. An apparatus for installing a fastener as set forth in claim 1 wherein said fastener holder includes a socket therein for receiving a resilient retainer clip.

13. An apparatus for installing a fastener as set forth in claim 1 wherein said floating coupling includes a shaft side and a fastener holder side, said floating coupling including in elastomeric member positioned between said shaft side and said holder side.

14. An apparatus for installing a fastener as set forth in claim 1 wherein said power source is operative to move said shaft to three distinct positions, including a home position, a load position, and a drive position.

15. An apparatus for installing a fastener on a workpiece comprising:
a drive member mounted for movement along a drive path; and
a floating coupling, said floating coupling connected between said drive member and a fastener holder, said floating coupling operative to vary the position of the fastener holder and allow said fastener holder to deviate from said drive path.

16. An apparatus for installing a fastener as set forth in claim 15 wherein the fastener is held in said fastener holder; and
said fastener and correspondingly said fastener holder deviating from said drive path based on contact between the fastener and the workpiece.

17. An apparatus for installing a fastener as set forth in claim 15 wherein said the floating coupling includes an elastomeric member.

18. A method for installing a fastener on a workpiece comprising the steps of:
loading the fastener in an apparatus for installing the fastener;
placing the workpiece in a fixture positioned adjacent the apparatus for installing the fastener;
actuating the apparatus to initiate the installation of the fastener such that the fastener contacts the workpiece; and
using a floating coupling to align the fastener with the workpiece such that the fastener is properly seated on the workpiece.

19. A method for installing a fastener on a workpiece as set forth in claim 18 wherein the step of using a floating coupling to align the fastener with the workpiece includes the step of providing an elastomeric member, a drive member and a fastener holder; and
using the elastomeric member to maintain a positional relationship between the fastener and the workpiece such that the fastener is properly seated on the workpiece.

20. A method for installing a fastener on a workpiece as set forth in claim 18 including the steps of positioning the apparatus in a load position and loading a fastener;
moving the apparatus to a home position and placing the workpiece in a fixture adjacent the apparatus; and
moving the apparatus to a drive position whereby the fastener is installed on the workpiece.
